(19) United States
(12) Patent Application Publication
(10) Pub. No.: US 2007/0069404 A1
(43) Pub. Date: Mar. 29, 2007

(54) Anionic purifier

(76) Inventor: Chin-Hsia Chi, Taichung Hsien (TW)

Correspondence Address: LEONG C LEI, PMB # 1008, 1867 YGNACIO VALLEY ROAD, WALNUT CREEK, CA, 94598, US

(21) Appl. No.: 11/235,221

(22) Filed: Sep. 27, 2005

(51) Int. Cl. B01F 3/04

(52) U.S. Cl. 261/81; 261/DIG. 48; 261/DIG. 65

(57) ABSTRACT

An anion purifier is disclosed. The purifier comprises a body, a water storage container for storing water and an oscillator for generating vapor, characterized in that the body has a front edge with a recessed space for holding the water storage container and the top section of the body is provided with a high concentration anion generating device such that after the anions blown out and mixed within the water storage container are mixed naturally with atomized vapor from the oscillator, forming into high oxygen content negative ions being blown out.

### BACKGROUND OF THE INVENTION

(a) Technical Field of the Invention

The present invention relates to anionic purifier having a body and a water storage container being mounted at the front edge of the body.

(b) Description of the Prior Art

Due to various types of electrical and electronic products being used in office and at home, our bodies are exposed to too much magnetic waves and as a result of confined office space, air ventilation is unhealthy, and therefore, our health is greatly affected. In order to improve the quality of air of the room, the anion and water vapor, have to be combined and the air of the room is appropriately purified.

Portable air purifiers for removing airborne particles are used in many homes and offices. These purifiers often include a fine particle high efficiency particulate air filter, and or some purifiers include a carbon filter to remove odors. The carbon may be incorporated within a fibrous matrix. A filter for trapping relatively large particles may also be found in portable air purifiers. In operation, one or more fans cause air to be drawn through the filter(s) and emitted through an outlet. These systems have been widely to consumers. In order to take full advantage of a filter or any other type of filter used in an air purifier, it is important to ensure that substantially all of the air emitted by the air purifier has indeed first passed through the filter(s) provided in the purifier.

### SUMMARY OF THE INVENTION

The primary purpose of the present invention is to provide an anionic purifier having a body, a water storage container for storing water and an oscillator for generating vapor, characterized in that the body has a front edge with a recessed space for holding the water storage container and the top section of the body is provided with a high concentration anion generating device such that after the anions blown out and mixed within the water storage container are mixed naturally with atomized vapor from the oscillator, forming into high oxygen content negative ions being blown out.

Yet another object of the present invention is to provide an anion purifier, wherein the bottom section of the water storage container is protruded out with an air pore for appropriate overflow.

Still another object of the present invention is to provide an anion purifier, wherein the top section of the body is provided with an insertion slot for the insertion of the anion-generating device.

A further object of the present invention is to provide an anion purifier, wherein the bottom section of the recessed space of the body is an insertion seat, allowing the water storage container to be directly mounted, so as to provide electrical connection of the oscillator.

Yet a further object of the present invention is to provide an anion purifier, wherein the water storage container is directly mounted within the hollow center of the body as a hidden device and the oscillator is directly locked at the bottom section of the water storage container for electrical connection.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the anionic purifier of the present invention.

FIG. 2 is a schematic view showing the anion-generating device of the present invention.

FIG. 3 is a schematic view of the anionic purifier of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

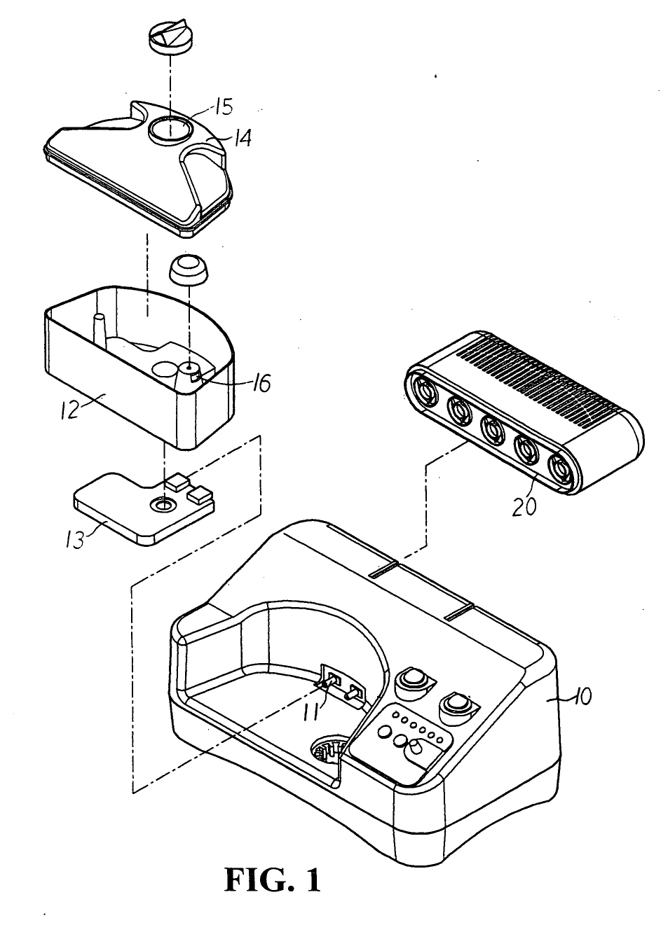

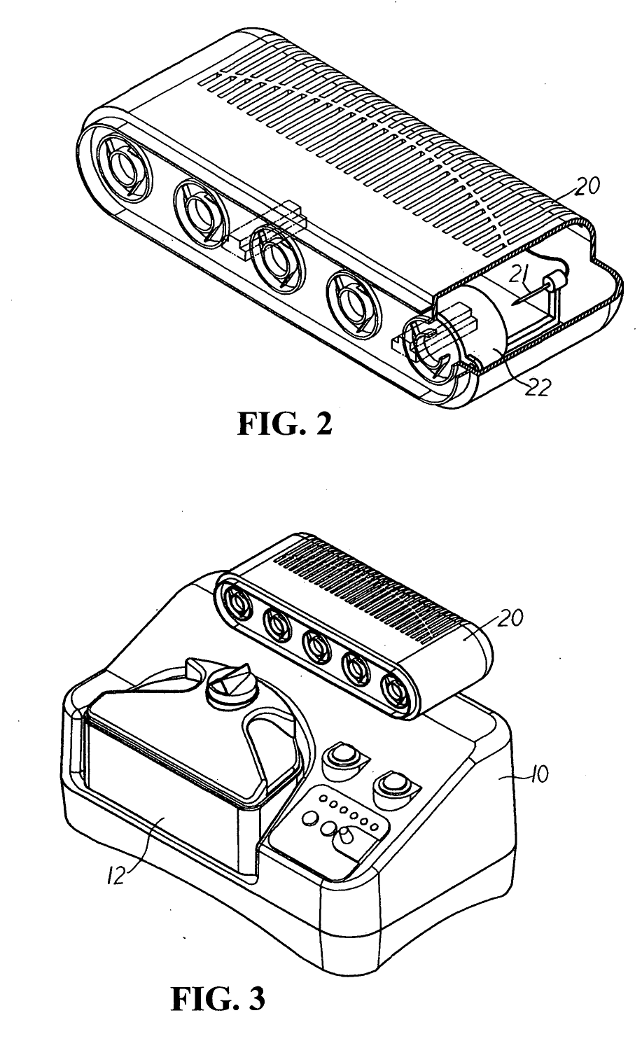

FIGS. 1 to 3 show an anionic purifier comprising a body 10 which is generally made from plastic and has a hollow structure. The front edge of the body 10 is a recessed space which is hidden space, and the bottom section of the recessed space is provided with a socket 11 for electrical connection of an insertion water storage container 12, and a high frequency oscillator 13 at the bottom section of the body of the container, after connected to a current supply, produces water vapor by oscillation of water and high frequency. The releasing port 15 at the top cover 14 of the container, releases the water vapor, and one side of the bottom section of the container is provided with an overflow and air pore 16 which is used for safety detection and for the convection control of water vapor so as to ensure the safety application of the oscillator 13. The water storage container 12 can be kept within the hollow interior of the body 10, and the entire oscillator 13 is directly adhered at the bottom section of the container as a connected module. The top face of the body 10 is provided with an insertion slot 17 which can directly lock the anionic generating device 20. When a power is switched on, negative voltage is generated at the needle rod 21 and in combination with a low charge metallic tube seat 22, which is appropriately spaced apart, when the tip of the needle rod 21 is supplied with high voltage, negative ions are generated. The low voltage electrode of the metallic tube seat 22 will attract a large amount of negative ions to form into bundle of ions being blown off. The atomized of pure water into water vapor by the oscillator will combined naturally with the negative ions, forming into atomized vapor with negative ions. The negative ions will dissolve in water vapor to form high concentration oxygen. Thus, the air is purified and the level of electrolyte in the human body is kept a balance.

In accordance with the present invention, the atomized vapor is mixed with negative ions to obtain high concentration oxygen. This allows the air within a confined space to be purified.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An anionic purifier having a body, a water storage container for storing water and an oscillator for generating vapor, characterized in that the body has a front edge with a recessed space for holding the water storage container and the top section of the body is provided with a high concentration anion generating device such that after the anions blown out and mixed within the water storage container are mixed naturally with atomized vapor from the oscillator, forming into high oxygen content negative ions being blown out.

2. The anionic purifier of claim 1, wherein the bottom section of the water storage container is protruded out with an air pore for appropriate overflow.

3. The anionic purifier of claim 1, wherein the top section of the body is provided with an insertion slot for the insertion of the anion-generating device.

4. The anionic purifier of claim 1, wherein the bottom section of the recessed space of the body is an insertion seat, allowing the water storage container to be directly mounted, so as to provide electrical connection of the oscillator.

5. The anionic purifier of claim 1, wherein the water storage container is directly mounted within the hollow center of the body as a hidden device and the oscillator is directly locked at the bottom section of the water storage container for electrical connection.
